(19) United States
(12) Patent Application Publication
(10) Pub. No.: US 2015/0161650 A1
(43) Pub. Date: Jun. 11, 2015

(54) AWARDABLE ENCRYPTED PASSWORDS

(71) Applicant: Paulo Roberto Jannotti Newlands, Rio de Janeiro (BR)

(72) Inventor: Paulo Roberto Jannotti Newlands, Rio de Janeiro (BR)

(21) Appl. No.: 14/098,296

(22) Filed: Dec. 5, 2013

(51) Int. Cl. G06Q 30/02; G06F 21/46

(52) U.S. Cl. CPC G06Q 30/0239; G06F 21/46

(57) ABSTRACT

Awardable Encrypted Passwords. Sets of Encrypted Master and Checker Passwords, randomly generated by independent electronic means, embedded in a dedicated Internet Website where a social network environment between customers, and commercial and official entities is established, those sets divided in two groups, the first formed by predefined Master Passwords housed in a Internet Website on behalf of those entities, and the second group formed by Checker Passwords to be distributed among customer of those entities out of which some having the right pre-codified Code previously generated in terms of amount, typology, and graphic meaning of the digits to match the required key to open the Master Passwords codification sequence in order to be recognized by the system as a winner Checker Passwords aiming to be eventually rewarded with prizes.

### TECHNOLOGY

1. Explanation of Password, according to the Current Federal Information Processing Standards (FIPS) 181 for Automated Password Generator (APG) issued in Oct. 5, 1993 by NIST—National Institute of Standards and Technology:

“A password is a protected character string used to authenticate the identity of a computer system user or to authorize access to system resources. When users are allowed to select their own passwords they often select passwords that are easily compromised. An automated password generator creates random passwords that have no association with a particular user.”

2. Automated Password Generator are well known in the state of the art such as the following examples commonly found at Internet, herein referred just for the sake of sustaining the premises of the present patent:
a) Secure Password Generator for Automated Password Generator Online at http://passwordsgenerator.net/;
b) MSD Services Software and System for Automated Password Generator Online at https://secure.msdservices.com;
c) Online Password Generator for Password Generator at http://onlinepasswordgenerator.com;
d) True Random Number Service for Random Password Generator at http://www.random.org/passwords/;
e) Norton Identity Safe for Password Manager at https://identitysafe.norton.com/;

### BACKGROUND OF THE INVENTION

1. Field of the Invention

The present invention generally relates firstly to the automatic creation, codification, production, classification and electronic storage of master encrypted Passwords into a system's website database, secondly to the distribution of Checker Encrypted Passwords all over the market to customers of products and services registered in the system and thirdly to the access and conference of encrypted Passwords stored in an accessible database at the system's website database by the customers of products and services of entities registered in the system's website, by using for this purpose the Checker Passwords collected by customers along with the products and services acquired from participant entities adhered to the system, the whole system operated with the support of a social network embedded in the Internet through which all participants, entities and customers, will interact about their consumption relationship that might eventually entitle customers to be rewarded with prizes.

Note: Although plenty of fundamental distinctions and concepts, the present patent represents an improved and workable evolution of similar system conceived and applied by the same inventor to the Brazilian Industrial Property Institute—(Instituto Brasileiro de Propriedade Industrial)/INPI under reference numbers PI 0601025-3 and CI 0601025-3 both for Combined Functions Card (Cartao Agregador de Funcoes).

2. Description of Related Art

The social website networks recently introduced in the Internet is increasingly becoming stronger and useful based on the many relevant services and applications it is able to offer for a broad variety of users in their daily life routine.

Thus, this community is daily connected to coordinate meetings, to exchange data and photos, to check the weather and climate, to update the news, to look for jobs and many others, everything done in real time in such a way that all sort of information circulates the entire globe instantly.

Recently, it has been noted that even commercial relationship actions between companies and clients, which traditionally were carried out only in the old fashion way via telephone, newspaper and television, are nowadays transiting regularly in the net in a very satisfactory pattern.

Paralleled, and as a complementary element of the commercial strategy of some entities to share the market, it is likewise common nowadays the distribution of any sort of reward to a parcel of clients one entity is dealing with aiming not only to increase the overall selling of the entity but also to announce and test new products and services for collecting in return client's experience and opinion about his consumption profile in such a way this monitoring process could be quite useful for increasing the quality of the entity's future business plans comprising customized conditions according to the returning information therefrom collected.

It should be remarked however that the existing awarding programs presently offered are not fully connected to a social network environment and differ from the present patent in the extent that the system presently disclosed provides a comprehensive and complete electronic awarding process within a social network environment, as previously described above, including the automatic creation, codification, production, classification and electronic storage of the encrypted Master Passwords into the system's website database, the distribution of the encrypted Checker Passwords to customers, as well as customer's independent access and conference of encrypted codes stored in an accessible database in order to know if he has was eventually rewarded with prizes, said system to be initiated and finalized within the same electronic environment, consequently adding not only full transparency and reliability to the system, but also universalizing global exchanging channels between users and entities for all relevant detail they must be aware about their consumption relationship, for the benefit of all parties involved.

The system is therefore entirely interactive between the parties, irrespective of the importance of each one in the social network created by the present patent.

### SUMMARY OF THE INVENTION

A system for independently create sets of encrypted Masters and Checker Passwords, to be stored in a Website database and afterwards to be distributed all over the market to customers of goods and services offered by entities previously registered in the system's website database, aiming the distribution of prizes, helping to get the relationship between entities and customers closer, as well improving the interaction between them almost in real time for the benefit of the quality of products and services they are offering and demanding.

### OBJECTS OF THE INVENTION

It is therefore an object of the present invention the automatic creation, codification, production, classification and electronic storage of the encrypted Master Passwords into the system's website database;

It is also an object of the present Invention the distribution of the encrypted Checker Passwords all over the market to customers of products and services registered in the system;

It is also an object of the present Invention to give access to customers for conference of the encrypted Passwords stored in an accessible database at the system's website;

It is also an object of the present Invention the distribution of Checker Passwords to customers along with the products and services acquired by them from the participant entities adhered to the present system;

It is also an object of the present Invention to disclose a system fully operated with the support of a social network embedded in the Internet through which all participants, entities and customers will interact about their consumption relationship;

It is also an object of the present Invention to help improving products and services rendered to the customers;

It is also an object of the present Invention eventually to reward customers with prizes.

In keeping with these objects and others that may become apparent, this invention relates to encrypted codes in an accessible database method and apparatus that might allow from one viewpoint, the improvement of quality of goods and service rendered to customers, and from another view, an addition in the level of customers satisfaction by giving them the opportunity of being eventually rewarded with prizes.

It is also an object of the present Invention to keep customers habits permanently monitored in order to better understand their consumption habits in order to improve the quality of the relationship between them and entities that have previously and voluntarily adhered to the system of the present patent.

It is also an object of the present Invention to create a relationship network suitable for discussion of customer's activities and preferences regarding brands, products, services as well as any other aspect that might be interesting for the knowledge and benefit of the parties.

It is also an object of the present Invention to permit users to contact the other users and/or review information about the user based on common interests regarding the goods and services they are acquiring;

It is also an object of the present Invention to arrange customers in various groups of interest inside the network where they will be able to find out a large supply of data and information regarding their consumption habits.

This aim can be achieved in an efficient manner just through the creation and storage in an accessible database, Master and Checker Passwords with which entities and customers will interact inside a social relationship network to achieve their individual goals.

The proper functioning of the present invention is fully guaranteed by the strong and reliable electronic nets already existing such as Internet, which apart of free its access is widely open to anyone looking for a global digitalized environment for interaction.

### BRIEF DESCRIPTION OF THE DRAWINGS

FIG. 1 is an overview of the schematic flow of the present system;

FIG. 2 shows the round and complete interaction between all parties involved in the system;

FIGS. from 3A to 3C give an exemplary structure of awarding plans possible to be launched through the present patent;

FIGS. from 4A to 4C show the routine to be followed as from the distribution of Checker Passwords up to the final checking at the System's Website.

FIGS. 5A and 5B disclose a model of printable bills comprising the insertion of a Password as well as a rebate.

FIGS. 6A and 5B exhibit two models of insertion of Password to physical goods.

### DETAILED DESCRIPTION

The way an awarding plan will distribute prizes after have become operative can be structured in a large variety of possibilities. Bellow follows an example among many others possible.

Therefore, the present invention will be better understood in connection with the accompanying drawings, in which:

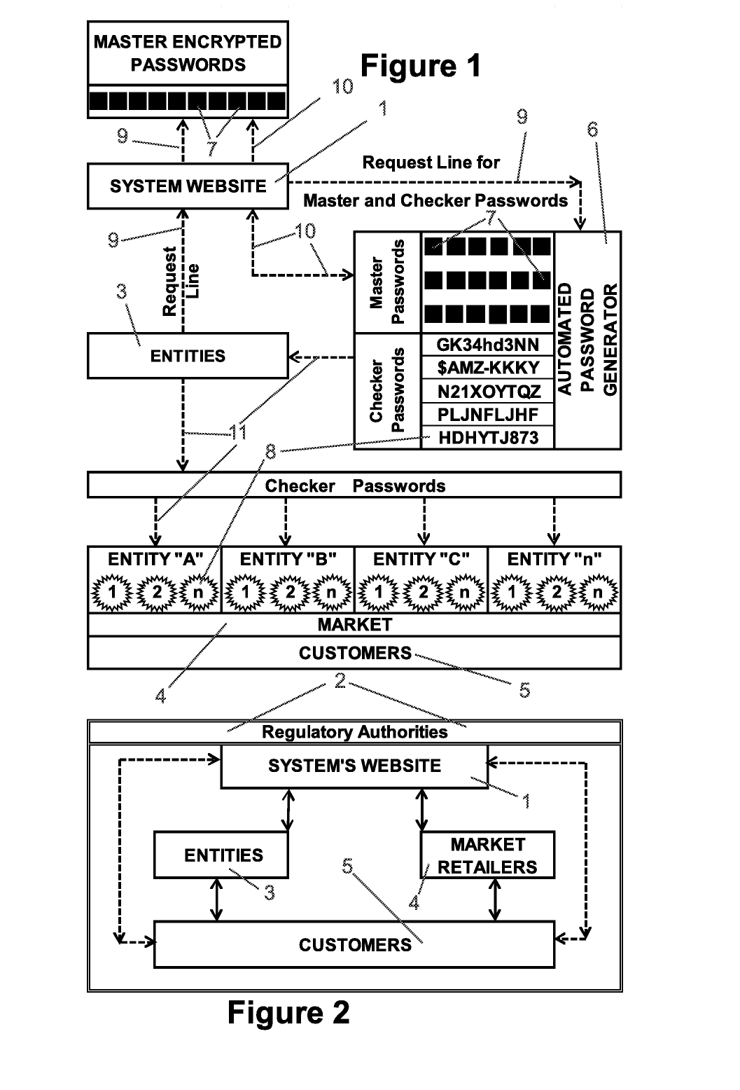

FIG. 1 shows an overview of the schematic flow of the present system based on the following main elements, among others:
A System's Website 1 which is the apparent digital face of the present patent where all the operational management and control is centralized in order to guarantee the perfect fulfillment of the awarding plans in force in a given moment. The System's Website 1, as well as all and any other structure and facility pertaining or related to the System, including those that are under the operational responsibility of the System will be permanently audited either by independent and official auditors, as well;
Regulatory Authorities 2 that are in charge for granting licenses, survey, control and exert all official functions and follow up of the awarding plans;
Entities 3 adhered to the System which refers to any private or public institution dealing or handling goods or service, provided that they maintain any kind of transaction with theirs customers 5 whom they guess should be awarded by a awarding campaign;
Market 4 that in this sense, is the set of final sellers and retailers of goods and service renderers of any size that actuate as the commercial interface of customer whom they are capable to deliver Checker Passwords 8 by any means;
Customers 5, the main party of the whole System for they are the microcell agent that will push the entire System ahead;
Automated Password Generator 6, as already referred hereto, is a very well-known equipment in the state of the art, comprising a conjugated hardware and software unit responsible for the generation of the Encrypted Master 7 and Checker 8 Passwords according to the conditions of each specific awarding plan.
Encrypted Master Passwords 7 generated by the Automated Password Unit 6 and sent to the Website System 1 to be afterwards identified by customers 5 through the Checker Passwords 8 distributed to them.
Encrypted Checker Passwords 8, also generated by the Automated Password Unit 6 for the distribution by the Entities 3 to their customers 5.
Software, not shown in FIG. 1, which is any digital element utilized to operate the System Website 1 herein represented not only by the digital program that controls the whole System including the Automated Password Generator 6, but also any peripheral digital system that might be needed according to the characteristics of any specific awarding plan.

Whenever an Entity 3 wants to launch a promotional awarding plan a request 9 is sent to the System Website 1 explaining the general and detailed conditions about the plan it wants to implement, asking as well for the production of both the Checker Passwords 8 it wants to spread out over the market 4, and the Master Passwords 7 that should be further posted, still encrypted, at the System Website 1 by the Website Operator.

Thence an identical request 9 is sent from the System's Website Operator to the Automated Password Generator 6 that remotely, automatically and exempt and protected from any human interference whatsoever will generate the required Master Passwords 7 for immediate sending 10 them to the System Website, and the Checker Passwords 8 for immediate sending 11 to the entity 3, so they could be distributed into the market 4 and finally to the customers 5.

After having received the Checker Passwords 8 from the Passwords Generator Unit 6, the Entity 3 will spread them out all over the geographical area covered by the launched program, supplying therefore all retailing point where customers 5 use to pick up their products or services.

At the moment customers 5 collect the items they have just purchased, they will be given along with those items an equivalent quantity of Checker Passwords 8 bearing each one its individual identification sequence of digits, still covered, with which they will be able to participate in the awarding plan linked to the goods or service a customer 5 is acquiring.

The kind of Checker Passwords 8 to be given to customers may largely vary pending upon the nature of the commercial transaction is being held between customers 5 and Entities 3.

For physical goods such as cans or bottles for example, the Checker Passwords 8 can be embodied to those items by printing the codes underneath an area covered by removable ink by scratching, for instance, or by fixing an adhesive portion of plastic material or the like containing a Checker Passwords 8, or by inserting the Checker Passwords 8 inside a product's cap 35, to give only few examples among many other possible that could be understood inside the scope of the present patent.

For some other physical goods, as well as for services, the passwords might be given in the format of printed coupon that alternatively can also be sent digitalized via the web.

For some others goods and operations, typically related to full digital transactions such as those made up by using credit or debit cards, parking lots, cinemas etc., the operation might be implemented by printing the digital codes on the receipt given to customers or even sent to them digitalized via Internet.

Next step for customers 5 is to unveil the identification sequence of digits in order to be aware about the digits they are going to use as Checker Passwords 8 to validate them or not, within the digital environment created by the present patent according to the exemplary routine prescribed by FIGS. 4A, 4B and 4C, as will be further explained.

It is important to state that some entities will use the system occasionally, whenever they want to carry on promotional campaigns for which they will establish specific plans.

Pending upon their kind of activity, some others entities may be able to settle permanent awarding programs provided that theirs operational way of activities allows it such as those credit or debit cards companies that for each time a debit or credit transaction is concluded, they use to give their customers a physic or digital receipt automatically set up and issued from a remote controller unit which according to the present patent might be able to insert Checker Passwords 8 into each new issued receipt, or even a rebate over the amount due.

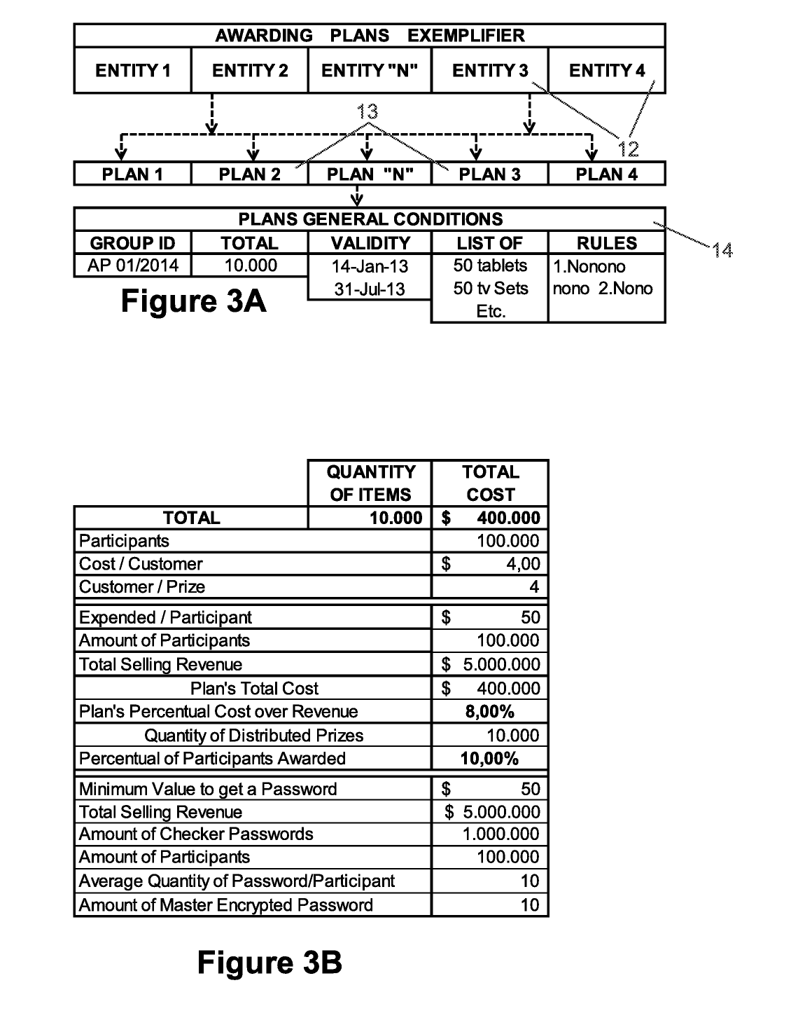

FIG. 2 shows the round and complete interaction between all parties involved in the system which is formed by the System Website 1, the Entities 3 adhered to the system, their Retailers located at the market's 4 final selling points to Customers 5.

The startup of the System generally happens in a passive mode and is firstly emulated whenever an interested entity 3 in settling a plan for promoting its products, brands and services sends a request to the System Website 1 informing the general conditions of the awarding program it wants to establish including all the related data and conditions pertaining to the program such as but not limited to geographical reach, periods of the program, group of products and services they will be offering as awarding to which one or more Checker Passwords 8 could be attributed, cost and selling prices of each item offered for rewarding, the amount of awarding items in terms of quantities and values, the advertising campaign to both customers and retailers, among many other data and information that might be needed to establish the projected plan.

After that, a contract prescribing the general conditions to which both the Website System 1 and the Entity 3 must abide will be signed by the parties including a Performance Bond or the like that must be presented by the Entity 3 as a guarantee for the complete fulfillment of the awarding plan projected.

Once the contract is signed by the parties, the System's Operator sends a request to the independent Automated Password Generator 6, as explained in FIG. 1, asking for the production of Master 7 and Checker 8 Passwords based upon the actuarial conditions set in force by the contract signed between them.

Upon receiving the request from System Operator 1, the Automated Password Generator 6 starts generating the codes, sending Checker Passwords 8 for the demanding Entity 3 either by digital means or in physical shape allowing so that Entity 3 to spread out those Checker Passwords 8 all over the market 4 it will cover, switching therefore the program to the operative mode.

At the same time, the Automated Password Generator 6 will be sending Master Passwords 7 to the System Website 1 which will disclose them in the web, still encrypted and covered, so that the Master Passwords 7 could be hit by customers 5 of the related products by using the Checker Passwords 7 they were given along with the products acquired.

It is worth to state that the whole process of generating the Encrypted Master 7 and Checker 8 Passwords is to be performed by the Automated Password Generator 6, since its initial point of request by the Entities 3 up to the final delivering of the Master Passwords 7 to the System Website 1 and Checker Passwords 8 to the demanding Entity 3, will be conducted in a hermetically closed electronic environment, similar to those exemplary models previously cited herein, without any human interference or knowledge about the content of the generated encrypted code.

Through the sequence of FIGS. from 3A to 3C, an exemplary kind of Awarding Plan is structured with the aim of better understanding the patent and its mathematic feasibility.

As such, on FIG. 3A it can be seen how multiple entities 12 are able to launch simultaneous Awarding Plans 13, each one of specific type and conditions 14 which might vary pending upon many factors such as the kind of business carried out by an entity, its client's profile, geographic region, period of the year, etc.

On FIG. 3B a sample of a possible accounting chart for an awarding plan is given by which a 10% out from an universe of 100.00 customers are rewarded by the Entity 3 based on a promoting cost of 8% over its revenues, for which 100.000 Checker Passwords 8 were distributed, out of which 10.000 are winner Checker Passwords 8.

It is worth to state that the winner Checker Password 8 should preferably be always formed by different digits and codification than the others, is such a way they would never be replicated or used by customers 5 in a second validation attempt at the System Website 1 meaning so that once a certain customer 5 has validated a specific winner Checker Password 8, there will never be a second one with identical codification, completely avoiding this way the risk of mishandling or fraud.

In other words, for any Master Password 7 to which more than one prize of the same type is allocated for distribution to customers 5, all winner Checker Passwords 8 entitled for those prizes will necessarily have different codifications.

The chart on FIG. 3C summarizes some of the relevant data regarding the prizes to be awarded and is divided in two blocks of elements, the upper and the lower block, both to be disclosed at the System Website before launching the plan.

This chart was created just as an example of how an awarding plan can be constructed and indexed in a comprehensive correspondence relation between the elements of the chart, for the aim of generating the Master 7 and Checker 8 Passwords of the present patent in a simple manner and without the risk of misunderstanding by the participants.

On the upper block of elements it is shown at column “A” the ten Master Encrypted Passwords 7 created and sequentially listed in column “B”, as established by that specific plan, those Master Encrypted Passwords 7, to be eventually unveiled by one of the winner Checker Passwords 8 distributed to customers.

Thus, at column “C” a pattern of encoded letters was created which, along with the digit existing in column “B”, will be part of the Checker Password 8 that a customer will be using to find out the kind of prize he was awarded which is listed at column “D”, after he had tested his Checker Password 8 through the System Website 1, according to the routine described by FIGS. 4A to 4C.

If succeeded in this phase, he will be then entitled to receive, according to this example, a sunglass that in this case is represented by the sequence “1 W”.

Column “E” states the available quantities per awardable item whilst column “F” inform the individual value of each item and column “G” its total prices, as well as the total value of the awardable prizes at the bottom of the column.

Columns “I” and “J” summarize the daily situation of quantities of prizes already given to customers 5 up to the date, allowing so a public and permanent surveillance about the development of each launched awarding plan by disclosing quantities of prizes already redeemed by customers at column “H”, and the remaining balance of prizes to be still distributed in column “I”.

The lower block of FIG. 3C contains an explanatory description about the correspondence meaning between the Encrypted Master Passwords 7 and the Checker Password 8 that will be used by customers during the validation process through the System Website 1.

The sequence of FIGS. from 4A to 4C finally describes the routine to be followed by customers to accomplish with the objectives of the present patent.

On FIG. 4A a summarized general view of the whole system is given in which the first step is the creation of an Internet Webpage 1 comprising a partially accessible database aimed to centralize all actions needed to start up and maintain the system's viability and credibility.

Next step comprises the registration of all entities willing to launch awarding plans which full details and conditions should be submitted for approval by the Web System 1 and the Regulatory Authorities 2, as well.

Once the entity 3 is notified by the System 1 that the submitted plan was approved, the entity 3 is then entitled to ask the System 1 to produce the Master 7 and Checker 8 Passwords based upon the structure of that specific awarding plan approved, leading so the system to automatically require the generation of those Passwords to the Passwords Generating System 6.

Next steps, according to FIG. 4A, is from one side to disclose the Master Passwords 7 still encrypted in the System Website 1 and from the other, spread the Checker Passwords 8, still covered, all over the market 4 through the retailers chain that entity is working with and thence to the related customers 5 who will be then entitled to unveil the received Checker Passwords 8 and check their status at the System Website 1 to find out if they have been awarded.

On FIG. 4B an example of the digital face that the System Website 1 might have is disclosed, for which an Internet Website 1, called in this example as “WEBPRIZES” 15 is created, comprising a database partially accessible from the outside and aiming to centralize all actions needed to start up and maintain the system's viability and credibility.

For a customer 5 who is contacting the System for the first time, he should hit the field “REGISTER HERE” 16 to start up his registration process in order to be able to interact with the System. If he is already a registered customer 5 or entity 3, then he goes straight to “LOGIN” 17 and “USERNAME” 18 to get himself logged into the system.

Upon logged he will be entitled to perform a variety of actions related or not to the specific awarding plan he is interested in, such as the following examples inserted in the FIG. 4C, among many others:

PROGRAMS 19: It is the room where all Awarding Programs currently in force or already finished will be disclosed, comprising a complete set of data and information such as Entities 3 name and full style, chart of prizes and all awarding conditions therefrom, regulations, list of prize winners as well as any other relevant information about those Awarding Programs.

By clicking this pad, any user of the System's Webpage, being registered or not, will be able to open the list of entities which are running awarding plans at that very moment.

Once he choose the entity which is running the awarding plan that he is participating in, he will click again, this time over the name of that Entity 3 and he will be then required to inform the PASSWORD 20 he has registered before that Entity 3 in order to be allowed to surf inside the Entities' plan for any desired purpose including the validation of the Checker Passwords 8 he might have.

CHECKER CODES CHART 21: By turning back to the field PASSWORDS 20, he will insert the digits pertaining to the password that he registered with the selected Entity 3 over which he will click again to gain access to the Checker Codes Chart 21.

Afterwards, a collection of frames vertically organized inside the Checker Codes Chart 21 will be opened to offer that customer 5 the options through which he is going to check out if the Checker Passwords 8 generated by the Passwords Generating Unit 6 were awarded, as better explained in the sequence.

FORUM 23: A digital environment created with the purpose of permitting the users of the System Website 1, namely customers 5 and entities 3, the interchanging of information related to that entity 3, its products, its awarding plan as well as any other subject pertaining to the commercial relationship.

PARTNERS 24: This section is destined to any kind of collateral subjects pertaining to the system such as official announcements, legislation, tutorials, jobs opportunities, as well as any other relevant matter that might interesting for the related community.

At the center of the Systems Website 1, a dedicated space 22 was reserved for updates and disclosing daily news related to the system and to the plans in motion such as a remarkable big prize awarding, new entering entities, expansion of geographical reach of a plan, etc.

The way the validation of Checker Passwords 8 will be concluded is disclosed by FIG. 4C.

After a customer 5 has been logged through the link of the entity 3 which is running the awarding plan he is participating in and consequently be allowed to surf inside the entities' plan, he will be able to get inside the CHECKER CODES CHART 21 where, according to the present example, four columns will be available, as follows:

TYPE CODE 25: It is the frame where customer 5 will take the first step to validate his Checker Passwords 8 by typing the digits of all Checker Passwords 8 he has just by clicking again over the option “TYPE CODE” 25 to emulate the next column of the chart;

RESULTS 26: At this column, the customer will be automatically informed by the system which Checker Passwords 8 was awarded. If he has one or more winner Checker Passwords 8, he will then click over each one, one at a time, to be automatically informed by the system the prize he is entitled to redeem which will be also automatically displayed at the “INDEX” 27 column in terms of two digits that can be checked just by clicking again over those two digits to emulate the chart of FIG. 3C which summarizes the prizes to be awarded by winner Checker Passwords 8;

TUTORIAL 28: After having defined the prize he was awarded a winner customer can have all necessary instruction about the process he must follows to redeem his prize just by clicking over the option “PRESS HERE” 29 and he will be guided for this aim.

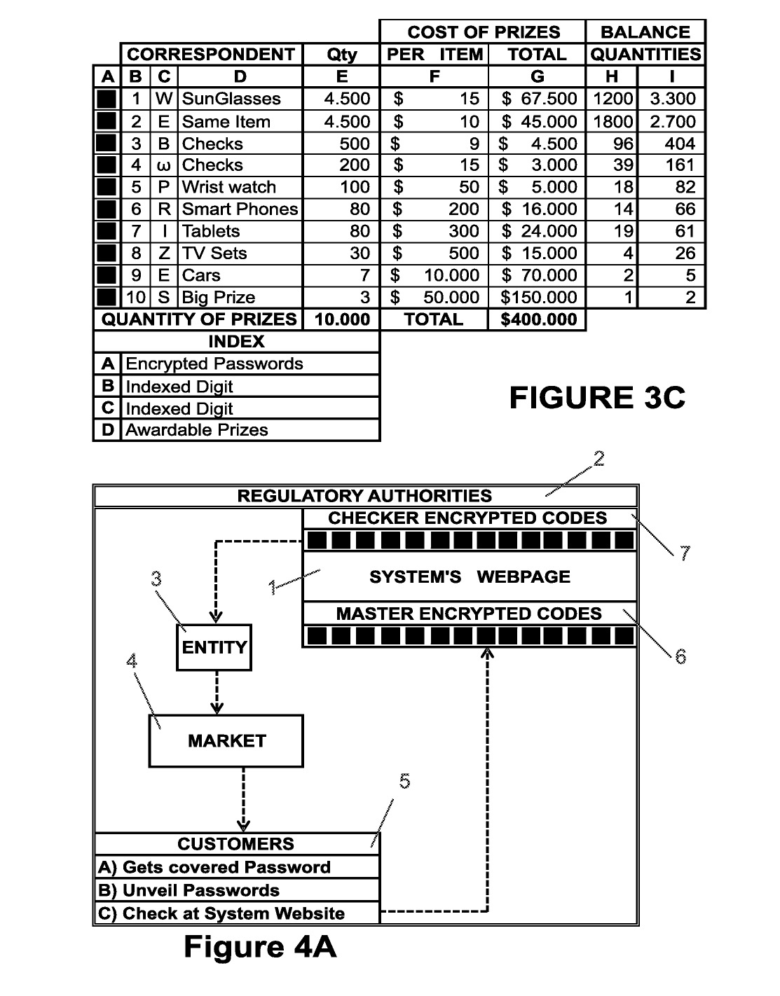

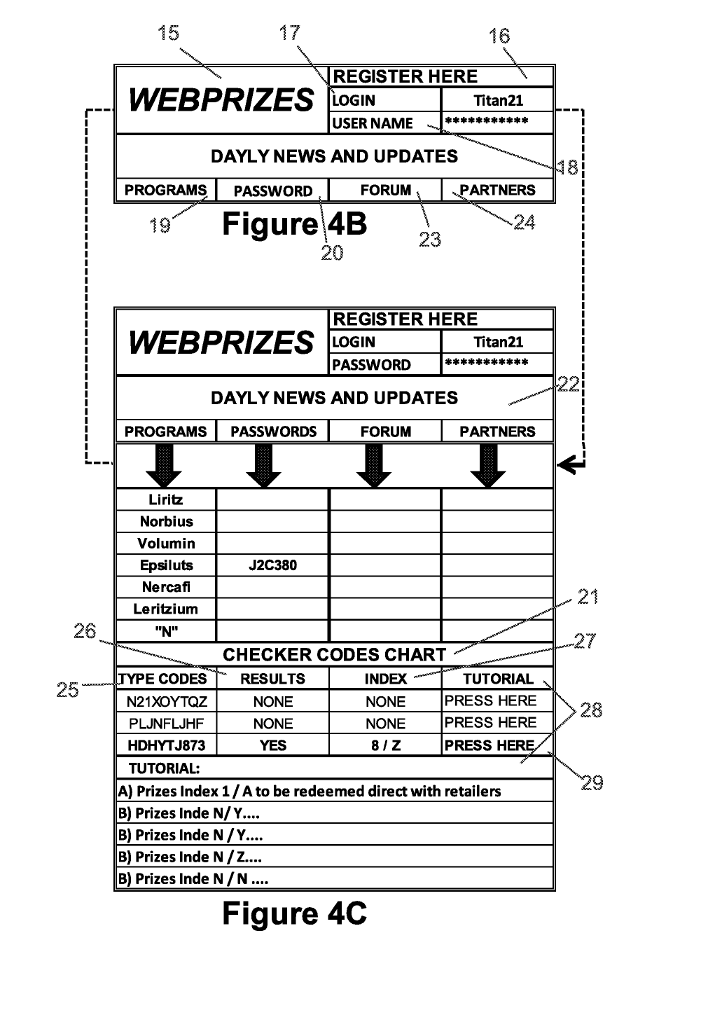

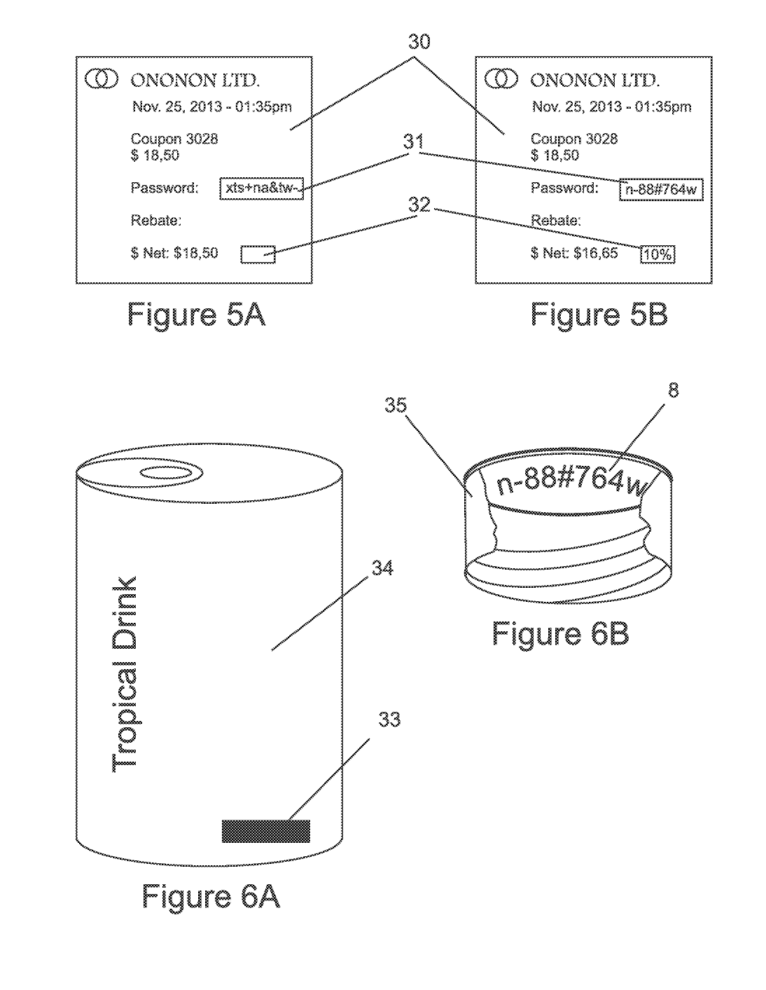

FIGS. 5A and 5B disclose models of printable accounting bills 30 comprising the fields for insertion of a Password 31 as well as a rebate 32. As such, on FIG. 5A there is an exemplary model of an accounting bill 30 normally used for payment of expenses via credit or debit cards, for instance, where at least two fields were inserted, the first one destined to inform that customer the pre-codified digits of the Checker Password 8 he was awarded and that can be used either in the System Website to check out if that Checker Password 8 bears the digits that can unveil the Master Password 7, or to be instantly awarded for a rebate 32 as shown in FIG. 5B.

6A and 6B exhibit two ways for the insertion of Checker Password 8 to physical goods, among many others possible.

On FIG. 6A, the insertion of a portion 33 at the bottom section of a soft drink can 34 is disclosed, which might be done either by printing a Checker Password 8 at that portion 33 and afterwards applying some scratching ink over it to permit customer to get access to his Checker Password 8 just by scratching the ink, or by fixing over that portion 33 an adhesive tape made up of plastic material or the like containing pre-codified digits of a Checker Passwords 8 printed in the reverse side of that adhesive tape, being the pre-codified digits disclosed just by detaching the adhesive portion from the can 34.

On FIG. 6B there is another possible way to get physical goods fitted with Checker Password 8 by which the pre-codified digits of a Checker Password 8 were printed in the ceiling of a soft drink cap 35 that will be disclosed just by detaching the cap 35 from the bottle where it was fixed.

While various embodiments have been described above, it should be understood that they have been presented by way of example only, and not limitation. For instance, any of the elements associated with the patent presentation may employ alternative functionality such as credit and debit card payment means, smartphones transactions or any other facility available. Thus, the breadth and scope of a preferred embodiment should not be limited by any of the above described exemplary embodiments.

I claim:

1. Awardable Encrypted Passwords consisting in sets of Encrypted Master and Checker Passwords, formed by any desired quantity of digits randomly generated by independent electronic means such as automated password generators without any kind of human interference, embedded in a dedicated Internet Website exclusively created for the aim of the present patent wherein these sets of Encrypted Passwords are divided in two main groups, the first group formed by a certain amount of predefined Master Passwords randomly formed by a desired quantity of encrypted digits, housed, and kept in a proprietary Internet Website on behalf of any entities adhered to the system thereby created, and the second group formed by a much larger quantity of Checker Passwords to be distributed among customer of entities adhered to system thereby created that will be operated through a social network environment where customers of any kind of good or service, commercial and official entities and general public will exchange all sort of information, procedure and action aiming to improve their mutual interest and the distribution of awards, as well.

2. Awardable Encrypted Passwords according to claim 1 wherein the present invention generally relates to the automatic creation, codification, production, classification and electronic storage of master encrypted Passwords into the system's website database, as well as to the distribution of checker encrypted Passwords all over the market to customers of products and services registered in the system and thirdly to the access and conference of encrypted Passwords stored in an accessible database at the system's website database by the customers of products and services of entities registered in the system's website, by using for this purpose Checker Passwords collected by customers along with products and services acquired from participant entities adhered to the system, the whole system operated with the support of a social network embedded in the Internet through which all participants, entities and customers, will interact about their consumption relationship that might eventually award customers with prizes.

3. Awardable Encrypted Passwords according to claims 1, and 2 wherein the startup of the System typically happens when an entity wanting to launch a promotional awarding program sends a request to the System's Website Operator explaining the general and detailed conditions about the program it wants to implement, asking as well for the production of both the Checkers Passwords it wants to spread out over the market, and the Master Passwords that should be further posted still encrypted, in the System′ Website which request is then sent from the System's Website Operator to the Automated Password Generator that remotely, automatically and exempt and protected from any human interference whatsoever and based upon the actuarial conditions set in force by that plan will generate the required Passwords, immediately sending the Master Passwords to the Website System's Operator and the Checker Passwords for the entity, so they could be distributed throughout the market and finally to the customers.

4. Awardable Encrypted Passwords according to claims 1, 2 and 3 wherein the Automated Password Generator starts generating the Passwords upon receiving the request from System Operator, sending Checker Passwords for the demanding Entity either by digital means or in physical shape allowing so the Entity to spread out those Passwords all over the market it will cover, switching therefore the program to the operative mode, sending at the same time the Master Passwords to the System Website which will disclose them, still encrypted, in the System's Webpage so that the Passwords could be digitally matched by customers of the related products through the Checker Passwords they were given along with the acquired products and services.

5. Awardable Encrypted Passwords according to claims 1, 2 and 3 wherein a predefined portion of Checker Passwords, out of the whole quantity distributed to customers of goods and services adhered to the system at any moment during the process of any commercial transaction, have their proper, right and precise pre-codified Encrypted Password previously, intentionally and mechanically generated in terms of amount, typology, and graphic meaning therein inserted in such a way that some of the Checker Passwords so formed will satisfy the required key to automatically unveil one of the Encrypted Master Passwords' codification sequence in order to be recognized by the system as a winner Checker Password entitled for an award.

6. Awardable Encrypted Passwords according to claims 1, 2 and 3 wherein the checking process through the system's website is preceded by the use of a predefined login and password and the interaction between the participants is processed through a social Internet network where the encrypted Passwords collected from goods and services should be used by customers to unveil and validate those Passwords previously stored in the Website of the system, aiming to be eventually awarded with prizes.

7. Awardable Encrypted Passwords according to claims 1, 2 and 3 wherein the system presently disclosed provides a comprehensive and complete electronic awarding process inside a social network environment including the automatic creation, codification, production, classification and electronic storage of master encrypted Passwords into the system's website database, the distribution of checker encrypted Passwords to customers, as well as customer's independent access and conference of encrypted Passwords stored in an accessible database in order to know if he was eventually awarded with prizes.

8. Awardable Encrypted Passwords according to claims 1, 2 and 3 wherein said system is to be independently initiated and finalized within the same electronic environment, consequently adding not only full transparency and reliability to the system, but also universalizing global exchanging channels between users and entities for all relevant detail they must be aware about their consumption relationship, for the benefit of the quality of products and services they are being offered and demanding.

9. Awardable Encrypted Passwords according to claims 1, 2 and 3 wherein the sets of generated encrypted Masters Passwords are to be stored in a website database and the encrypted Checkers Passwords are to be distributed all over the market to customers of goods and services offered by entities after they have been previously registered in the system's website in order to support the interaction between them in real time.

10. Awardable Encrypted Passwords according to claims 1, 2 and 3 wherein the operational structure is formed among others by a Website which is the apparent digital face of the present patent in which all the operational control is centralized in order to guarantee the permanent and entire fulfillment of the awarding plans in force by the Entities adhered to the System such as the market and retailers, the customers, the Automated Password Generator, Software, and Regulatory Authorities, being individual customers and adhered entities organized in various groups of interest inside the network system where they will be able to find out a large supply of data and information regarding their consumption habits.

11. Awardable Encrypted Passwords according to claims 1, 2 and 3 wherein customers will be given a certain quantity of Checker Passwords equivalent to the quantity of items they have purchased according to the rules of the related awarding plan, bearing each Checker Password its individual identification sequence of digits, still covered, with which customers will be able to participate in the awarding program linked to the goods or service they have acquired just by unveiling the identification sequence of digits attributed to theirs Checker Passwords and use them within the digital environment created by the present patent.

12. Awardable Encrypted Passwords according to claims 1, 2 and 3 wherein the whole process of generating the encrypted Master and Checker Passwords is performed by an Automated Password Generator since the beginning up to the final delivering of the Master Passwords to the System's Website, and Checker Passwords to the demanding Entity, in a hermetically closed electronic environment, without any human interference or any external knowledge about the content of the generated encrypted Password.

13. Awardable Encrypted Passwords according to claims 1, 2 and 3 wherein the winner Checker Passwords will be formed by different digits and codification is such a way they would never be replicated or used by customers in a validation attempt at the System's Website meaning so that once a certain customer has validate a specific winner Checker Password, there will be never a second one with identical codification, completely avoiding this way the risk of fraud.

14. Awardable Encrypted Passwords according to claims 1, 2 and 3 wherein a awarding plan is construed and indexed in a comprehensive correspondence between its fundamental elements for the aim of generating Master and Checker Passwords in a simple manner and without the risk of being misunderstood by the participants, as required by the awarding plan.

15. Awardable Encrypted Passwords according to claims 1, 2 and 3 wherein a daily position of quantities of prizes already given up the date by a specific awarding plan will be announced at the System's Website allowing so a transparent and permanent surveillance about the development of each launched awarding plan by disclosing quantities of prizes already redeemed by customers and the remaining balance of prizes still to be distributed.

16. Awardable Encrypted Passwords according to claims 1, 2 and 3 wherein an explanatory description about the correspondence meaning between the Encrypted Master Passwords and the Checker Password that will be used by customers during the validation process through the System's Website Page, as well as the routine to be followed by customers to accomplish with the objectives of the present patent will be clearly announced in the System's Webpage.

17. Awardable Encrypted Passwords according to claims 1, 2 and 3 wherein the creation of an awarding accessible database aimed to centralize all actions needed to start up and maintain the system's viability and credibility comprises the steps of registering all entities willing to launch awarding plans, submission and approval of their specific plan by all internal and external levels of approval, predetermining of the necessary quantity of Master and Checker Passwords based upon the structure of that specific awarding plan approved, generation of the Passwords by the Passwords Generating System, disclosure of the Master Passwords, still encrypted, in the System's Webpage, spread Checker Passwords, still covered, all over the market and to the customers of that entity who will be then entitled to unveil the Passwords received and check them at System Webpage to find out if they were awarded.

18. Awardable Encrypted Passwords according to claims 1, 2 and 3 wherein the System's Webpage is the digital face of the patent through which entities and customers will interact by means of the various tools available such as but not limited to a “REGISTER HERE” pad useful for registration of new users, “LOGIN” and “PASSWORD” pads for those customers already registered, “PLANS” where all Awarding Programs currently in force or already finished will be disclosed, “PASSWORDS” frame where customer will type the Checker Passwords he has, a “FORUM” pad created with the purpose of permitting the users of the System's Website to exchange Information, a “GUIDELINES” pad destined to announce any kind of collateral subject pertaining to the system, a room at the center of the System's Webpage dedicated to disclose daily news and updates regarding the plans in motion, a “CHECKER PASSWORDS CHART” pad that upon hitting will open additional frames such as “TYPE PASSWORD” where customer will type the digits of all Checker Passwords he has, “RESULTS” where customers will be automatically informed about which winner Checker Passwords he has over which he must click again to automatically be informed about the prize he is entitled to redeem which will be also automatically displayed at the “INDEX” list in terms of two digits that combined will express the kind of prize that Checker Password was awarded which after have been clicked over will open a “TUTORIAL” pad where customer will have all necessary instruction about the process he must follows to redeem his prize just by clicking over the option “PRESS HERE” and he will be guided for this aim.

19. Awardable Encrypted Passwords according to claims 1, 2 and 3 wherein some entities will use the system occasionally, whenever they want to carry on promotional campaigns for which they will establish specific plans while some others entities may be able to settle permanent awarding programs whenever it might be allowed by their kind of operational procedures such as credit or debit cards companies that for each time a debit or credit transaction is concluded they might insert Checker Passwords in each bill retrieved by customers after any transaction.

20. Awardable Encrypted Passwords according to claims 1, 2 and 3 wherein the patent functionality may employ alternative means such as credit and debit card payment means, smartphones transactions or any other facility available and feasible for the aim of the patent.

21. Awardable Encrypted Passwords according to claims 1, 2 and 3 wherein any kind of rendered service such as cinema, parking lots, transportation, public venues like stadiums or any other being operated and controlled through the emission of tickets or the like might be using the system regularly in order to be allowed to get the Checker Passwords incorporated to the digital as well as to the printed or printable tickets to be delivered to their customers.

22. Awardable Encrypted Passwords according to claims 1, 2 and 3 wherein an optional on-line system is available for giving customers, instantly and in real time, a rebate for an account he is paying at that moment, the rebate in a variable percentage randomly selected by the system up to one hundred percent (100%), the Password related to that given rebate to be printed instantly along with all other data pertaining to that transaction and immediately sent to the system's data base as an unveiled encrypted Checker Password for accounting purposes.

23. Awardable Encrypted Passwords according to claims 1, 2 and 3 wherein a digital relationship community is able to be connected all the time to exchange consumption habits and experiences about entities, products and services, as well as to coordinate meetings, to exchange data and photos, to check the weather and climate, to update the news, to look for jobs as well as many other actions, everything done in real time in such a way that all sort of information circulates the entire globe instantly.
